(19) United States
(12) Patent Application Publication
(10) Pub. No.: US 2020/0079796 A1
(43) Pub. Date: Mar. 12, 2020

(54) METHODS OF MAKING NANOSTRUCTURED METAL-ORGANIC FRAMEWORKS

(71) Applicant: THE BOARD OF TRUSTEES OF THE UNIVERSITY OF ALABAMA, Tuscaloosa, AL (US)

(72) Inventors: Seyed Fatemeh Seyedpour, Babol (IR); Ahmad Rahimpour, Babol (IR); Milad Rabbani Esfahani, Northport, AL (US)

(21) Appl. No.: 16/537,806

(22) Filed: Aug. 12, 2019

Related U.S. Application Data
(60) Provisional application No. 62/727,813, filed on Sep. 6, 2018.

(51) Int. Cl. C07F 1/00; C07F 1/08; C07F 3/06; C07F 15/06; C07F 15/04; C07F 13/00; C07F 3/00; B01J 31/22; B01D 39/16; B01D 53/02; C02F 1/28

(52) U.S. Cl. CPC C07F 1/005; C07F 1/08; C07F 3/06; C07F 15/065; C07F 15/045; C07F 13/005; C02F 2101/308; B01J 31/2208; B01D 39/16; B01D 53/02; C02F 1/285; B01D 2253/204; C07F 3/003

(57) ABSTRACT

Disclosed herein are methods of making nanostructured metal-organic frameworks. The methods include contacting a homogenized ligand solution with a homogenized aqueous metal salt solution at room temperature to form a mixture; and agitating the mixture for an amount of time to thereby form the nanostructured metal-organic framework at room temperature; wherein the homogenized ligand solution comprises a ligand dispersed substantially homogenously in a solvent selected from the group consisting of water, ethanol, isopropanol, n-propanol, lactic acid, and combinations thereof; and wherein the homogenized aqueous metal salt solution comprises a metal salt dispersed substantially homogenously in an aqueous solvent. Also disclosed herein are nanostructured metal-organic frameworks made by the methods described herein. Also disclosed herein are articles of manufacture comprising nanostructured metal-organic frameworks made by the methods described herein, such as filters, respirators, gas masks, human protection devices, catalysts, and catalyst supports.

### CROSS-REFERENCE TO RELATED APPLICATIONS

This application claims the benefit of priority to U.S. Provisional Application No. 62/727,813 filed Sep. 6, 2018, which is hereby incorporated herein by reference in its entirety.

### BACKGROUND

Metal Organic Frameworks (MOFs), more generally speaking coordination polymers (CPs), are a class of nanostructured porous hybrid materials assembled via coordination bonds between metal-containing centers and organic linkers (Long et al. Chemical Society Reviews 2009, 38(5), 1213-1214). In comparison to traditional inorganic microporous structures such as zeolites, metal-organic frameworks have a tunable structure, flexibility, structural diversity, high surface area, high pore volume, uniform pore size, and well-defined molecular adsorption sites, which can be designed at the atomic scale by using different metals or proper selection of the organic linker. Due to their high surface area and versatility, metal organic frameworks are interesting for diverse applications including gas storage/separation, conductivity/semiconductivity, chemical sensing, catalysis, luminescence, energy conversion, sensors, removal of hazardous materials, membrane separation, drug delivery, and others. Metal-organic frameworks are generally prepared via hydro/solvothermal approaches that comprise electrical heating in small scale at high temperature and long reaction time, e.g., from several hours to days (Lee et al. Korean Journal of Chemical Engineering 2013, 30 (9), 1667-1680). Microwave-assisted, sonochemical, electrochemical, and mechanochemical methods are alternative synthesis procedures developed with the aim of decreasing the synthesis time and producing smaller and more uniform crystals. Despite the significant efforts in this field, there is limited synthesis scale-up for industrial applications and there is still a critical need for the development of facile, rapid, inexpensive, commercially viable, high-rate, high-quality, and/or environmentally friendly production of metal-organic frameworks. The methods described herein address these and other needs.

Additionally, combining nanosized metal-organic frameworks with the advantages of mesoporous metal-organic frameworks would create a new generation of metal-organic framework materials for a wide variety of applications. Despite exhibiting great importance for many applications, nanosized metal-organic frameworks have attracted less attention compared to their bulk crystals (U.S. Pat. No. 8,668,764). This fact arises from the lack of an efficient strategy for synthesizing well-defined nanosized metal-organic frameworks. Accordingly, an efficient strategy for synthesizing well-defined nanosized metal-organic frameworks is needed. The methods described herein address these and other needs.

### SUMMARY

In accordance with the purposes of the disclosed compositions and methods, as embodied and broadly described herein, the disclosed subject matter relates to compositions and methods of making and using the compositions. More specifically, according to the aspects illustrated herein, disclosed are methods of making nanostructured metal-organic frameworks and methods of use thereof.

Disclosed herein are methods of making a nanostructured metal-organic framework, the methods comprising: contacting a homogenized ligand solution with a homogenized aqueous metal salt solution at room temperature to form a mixture; and agitating the mixture for an amount of time to thereby form the nanostructured metal-organic framework at room temperature; wherein the homogenized ligand solution comprises a ligand dispersed substantially homogenously in a solvent selected from the group consisting of water, ethanol, isopropanol, n-propanol, lactic acid, and combinations thereof and the homogenized aqueous metal salt solution comprises a metal salt dispersed substantially homogenously in an aqueous solvent.

The homogenized ligand solution can, for example, comprise the ligand in an amount of from 0.05 to 0.1 gram per 100 mL of solvent. The ligand can, in some example, comprise 1,3,5-Benzenetricarboxylic acid (BTC), 2-Aminoterephthalic acid (BDC-NH₂), Terephthalic acid (BDC), or a combination thereof. In some examples, the solvent comprises ethanol.

The methods can, in some examples, further comprise forming the homogenized ligand solution by contacting the ligand with the solvent under agitation to form a pre-homogenized ligand solution and homogenizing the pre-homogenized ligand solution to form the homogenized ligand solution. In some examples, the ligand is contacted with the solvent under agitation and the agitation comprises mechanical stirring. In some examples, the ligand is contacted with the solvent under agitation for an amount of time from 5 minutes to 30 minutes to form the pre-homogenized ligand solution. Homogenizing the pre-homogenized ligand solution can, for example, comprise sonicating the pre-homogenized ligand solution. In some examples, the pre-homogenized ligand solution is sonicated for an amount of time from 1 minute to 10 minutes to form the homogenized ligand solution.

In some examples, the homogenized aqueous metal salt solution comprises the metal salt in an amount of from 0.2 to 0.5 per 100 mL of aqueous solvent. The metal salt can, for example, comprise a metal selected from the group consisting of Be, Mg, Al, Ca, Sc, Ti, V, Cr, Mn, Fe, Co, Ni, Cu, Zn, Ga, Zr, Mo, Ag, Cd, Sn, Ba, W, Pt, Au, Hg, Tl, Pb, Bi, and combinations thereof. In some examples, the metal salt can comprise a metal selected from the group consisting of Ag, Cu, Zn, Co, Ni, Mn, Cd, and combinations thereof. In some examples, the metal salt comprises silver acetate, zinc acetate dihydrate, copper (II) acetate hydrate, cobalt (II) acetate tetrahydrate, manganese (II) acetate tetrahydrate, manganese (II) acetate tetrahydrate, cadmium acetate dihydrate, nickel(II) acetate tetrahydrate, or combinations thereof

The aqueous solvent comprises water. In some examples, the aqueous solvent further comprises an additional solvent selected from the group consisting of methanol, ethanol, isopropanol, n-propanol, lactic acid, and combinations thereof.

In some examples, the methods can further comprise forming the homogenized aqueous metal salt solution by contacting the metal salt with the aqueous solvent under agitation to form a pre-homogenized aqueous metal salt solution and homogenizing the pre-homogenized aqueous metal salt solution to form the homogenized aqueous metal salt solution. The metal salt can, for example, be contacted with the aqueous solvent under agitation and the agitation comprises mechanical stirring. In some examples, the metal salt can be contacted with the aqueous solvent under agitation for an amount of time from 5 minutes to 30 minutes to form the pre-homogenized aqueous metal salt solution. Homogenizing the pre-homogenized aqueous metal salt solution can, for example, comprise sonicating the pre-homogenized aqueous metal salt solution. In some examples, the pre-homogenized aqueous metal salt solution is sonicated for an amount of time from 1 minute to 5 minutes to form the homogenized aqueous metal salt solution.

Agitating the mixture can, for example, comprise mechanical stirring. In some examples, the mixture is agitated for an amount of time of 30 minutes or less (e.g., 20 minutes or less, 10 minutes or less, or 5 minutes or less) to form the nanostructured metal-organic framework.

In some examples, the nanostructured metal-organic framework is formed in an amount of time of 30 minutes or less (e.g., 20 minutes or less, 10 minutes or less, or 5 minutes or less). The nanostructured metal-organic framework can, for example, comprise Ag-BTC, Ag/NH₂-BDC, Ag-BDC, Cu-BTC, Cu-BDC, Zn-BTC, Co-BTC, Ni-BTC, Mn-BTC, Cd-BTC, or combinations thereof.

In some examples, the nanostructured metal-organic framework can comprise a plurality of particles having an average particle size of from 1 nanometer (nm) to 1 micrometer (um, micron). The nanostructured metal-organic framework can, for example, comprise a plurality of particles having a shape that is substantially that of a fiber, a sheet, a rod, a sphere, or a combination thereof. In some examples, the nanostructured metal-organic framework comprises a plurality of substantially fiber-like particles having an average diameter of from 10 nm to 100 nm (e.g., from 30 to 50 nm). In some examples, the nanostructured metal-organic framework comprises a plurality of substantially rod-shaped particles having an average diameter of from 1 nm to 100 nm (e.g., from 25 to 40 nm). In some examples, the nanostructured metal-organic framework comprises a plurality of substantially sheet-like particles having an average thickness of from 1 to 100 nm. In some examples, the nanostructured metal-organic framework comprises a plurality of substantially spherical particles having an average diameter of from 200 nm to 600 nm.

The nanostructured metal-organic framework can, for example, have a BET surface area of from 5 to 500 m²/g. In some examples, the nanostructured metal-organic framework has an average pore volume of from 0.024 to 0.8 cm³/g. In some examples, the nanostructured metal-organic framework has an adsorption capacity for nitrogen gas of from 5 to 500 m²/g of nanostructured metal-organic framework. In some examples, the nanostructured metal-organic framework is antimicrobial.

In some examples, the methods can further comprise collecting the nanostructured metal-organic framework. In some examples, the methods can further comprise washing the collected nanostructured metal-organic framework. In some examples, the methods can further comprise drying the collected nanostructured metal-organic framework.

The methods can, in some example, be performed in the substantial absence of organic solvents.

Also disclosed herein are nanostructured metal-organic frameworks made by any of the methods described herein. Also disclosed herein are filters for removing a gas from a gas stream, said filter comprising a nanostructured metal-organic framework formed by any of the methods described herein. Also disclosed herein are respirators and gas masks comprising the filters described herein. Also disclosed herein are human protection devices comprising a fabric and a nanostructured metal-organic framework formed by any of the methods described herein.

Also disclosed herein are filters for removing a component from a fluid stream said filter comprising a nanostructured metal-organic framework formed by any of the methods described herein. For example, the filter can comprise a desalination filter, a wastewater treatment filter, a dye removal filter, a heavy metal removal filter, or a combination thereof.

Also disclosed herein are catalysts and/or catalyst supports comprising a nanostructured metal-organic framework formed by any of the methods described herein.

Additional advantages of the disclosed compositions and methods will be set forth in part in the description which follows, and in part will be obvious from the description. The advantages of the disclosed compositions will be realized and attained by means of the elements and combinations particularly pointed out in the appended claims. It is to be understood that both the foregoing general description and the following detailed description are exemplary and explanatory only and are not restrictive of the disclosed compositions, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 is a photograph of as synthesized Ag-BTC nanofibers.

FIG. 2 is a FE-SEM image of the Ag-BTC nanofibers.

FIG. 3 is a FE-SEM image of the Ag-BTC nanofibers.

FIG. 4 is a FE-SEM image of the Ag-BTC nanofibers.

FIG. 5 is the XRD pattern of the synthesized Ag-BTC nanofibers (top spectrum) in comparison to its relevant simulation (bottom spectrum).

FIG. 6 is the EDX spectrum of Ag-BTC.

FIG. 7 is the EDX-mapping of carbon atoms in Ag-BTC.

FIG. 8 is the EDX-mapping of silver atoms in Ag-BTC.

FIG. 9 is a FE-SEM image of the Ag—NH₂ nanofibers.

FIG. 10 is a FE-SEM image of the Ag—NH₂ nanofibers.

FIG. 11 is a FE-SEM image of the Ag—NH₂ nanofibers.

FIG. 12 is a FE-SEM image of the Ag-BDC nanosheets.

FIG. 13 is a FE-SEM image of the Ag-BDC nanosheets.

FIG. 14 is a FE-SEM image of the Ag-BDC nanosheets.

FIG. 15 is a FE-SEM image of the Cu-BTC nanorods and nanoparticles.

FIG. 16 is a FE-SEM image of the Cu-BTC nanorods and nanoparticles.

FIG. 17 is a FE-SEM image of the Cu-BDC nanorods.

FIG. 18 is a FE-SEM image of the Cu-BDC nanorods.

FIG. 19 is a FE-SEM image of the Zn-BTC nanorods.

FIG. 20 is a FE-SEM image of the Zn-BTC nanorods.

FIG. 21 is the XRD pattern of the as-synthesized Zn-BTC nanorods (top spectrum) in comparison to its relevant simulation (bottom spectrum).

FIG. 22 is a FE-SEM image of the Co-BTC cubic orthorhombic nanorods.

FIG. 23 is a FE-SEM image of the Co-BTC cubic orthorhombic nanorods.

FIG. 24 is a FE-SEM image of Ni-BTC nanosheets.

FIG. 25 is a FE-SEM image of Ni-BTC nanosheets.

FIG. 26 is a FE-SEM image of Mn-BTC nanospheres.

FIG. 27 is a FE-SEM image of Mn-BTC nanospheres.

FIG. 28 is a FE-SEM image of Mn-BTC nanospheres.

FIG. 29 is a FE-SEM image of Cd-BTC nanosheets.

FIG. 30 is a FE-SEM image of Cd-BTC nanosheets.

FIG. 31 is the XRD pattern of Zn-BDC.

FIG. 32 is the XRD pattern of Zn—NH₂-BDC.

FIG. 33 is the XRD pattern of Cd-BTC.

FIG. 34 is the XRD pattern of Co-BTC.

FIG. 35 is the XRD pattern of Mn-BTC.

FIG. 36 is the XRD pattern of Ni-BTC.

FIG. 37 is the XRD pattern of Cu-BTC.

The simulated data were extracted from the Cambridge Crystallographic Data Centre (CCDC) and the crystal structure were assessed by material studio 8.0 software.

### DETAILED DESCRIPTION

The nanostructured metal-organic frameworks and methods described herein may be understood more readily by reference to the following detailed description of specific aspects of the disclosed subject matter and the Examples included therein.

Before the present nanostructured metal-organic frameworks and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

Reference will now be made in detail to specific aspects of the disclosed materials, compounds, compositions, formulations, articles, and methods, examples of which are illustrated in the accompanying Examples and Figures.

### Methods of Making Nanostructured Metal-Organic Frameworks

Disclosed herein are methods of making nanostructured metal-organic frameworks. Metal-Organic Frameworks (MOFs), more generally speaking coordination polymers (CPs), are a class of nanostructured porous hybrid materials assembled via coordination bonds between metal-containing centers and organic linkers (Long et al. Chemical Society Reviews 2009, 38(5), 1213-1214). As used herein, “nanostructured” means any structure with one or more nanosized features. A nanosized feature can be any feature with at least one dimension less than 1 μm in size. For example, a nanosized feature can comprise a nanowire, nanotube, nanoparticle, nanopore, and the like, or combinations thereof. As such, the nanostructured metal-organic frameworks can comprise, for example, a nanowire, nanotube, nanoparticle, nanopore, or a combination thereof. In some examples, the nanostructured metal-organic frameworks can comprise a material that is not nanosized but has been modified with a nanowire, nanotube, nanoparticle, nanopore, or a combination thereof.

The methods of making the nanostructured metal-organic frameworks comprise contacting a homogenized ligand solution with a homogenized aqueous metal salt solution at room temperature to form a mixture. As used herein, room temperature means at a temperature of from 14° C. to 25° C. (e.g., from 18° C. to 25° C.).

The homogenized ligand solution comprises a ligand dispersed substantially homogenously in a solvent. As used herein, a “homogenized” solution or a solution where a component is dispersed “substantially homogeneously” in a solvent generally refers to a solution that is substantially uniform throughout with respect to the local concentration of the component dispersed in the solvent, without any small particle. As used herein, a homogenized solution refers to solutions in which 80% of the solution (e.g., 85% of the solution, 90% of the solution, or 95% of the solution) has a local concentration lies within 25% of the average concentration (e.g., within 20% of the average concentration, within 15% of the average concentration, within 10 of the average concentration, or within 5% of the average concentration).

The homogenized ligand solution can comprise a ligand dispersed substantially homogenously in a “green” solvent. For example, the homogenized ligand solution can comprise a ligand dispersed substantially homogenously in a solvent selected from the group consisting of water, alcohols (e.g., methanol, ethanol, n-butanol, isopropanol, n-propanol), carboxylic acids (e.g., acetic acid, lactic acid), and combinations thereof In some examples, the homogenized ligand solution can comprise a ligand dispersed substantially homogenously in a solvent comprising ethanol.

The ligand can, for example, comprise 1,3,5-Benzenetricarboxylic acid (BTC), 2-Aminoterephthalic acid (BDC-NH₂), Terephthalic acid (BDC), or a combination thereof.

In some examples, the homogenized ligand solution can comprise the ligand in an amount of 0.05 grams or more per 100 mL of solvent (e.g., 0.055 grams or more, 0.06 grams or more, 0.065 grams or more, 0.07 grams or more, 0.075 grams or more, 0.08 grams or more, 0.085 grams or more, or 0.09 grams or more). In some examples, the homogenized ligand solution can comprise the ligand in an amount of 0.1 grams or less per 100 mL of solvent (e.g., 0.095 grams or less, 0.09 grams or less, 0.085 grams or less, 0.08 grams or less, 0.075 grams or less, 0.07 grams or less, 0.065 grams or less, or 0.06 grams or less). The amount of ligand in the homogenized ligand solution can range from any of the minimum values described above to any of the maximum values described above. For example, the homogenized ligand solution can comprise the ligand in an amount of from 0.05 to 0.1 grams per 100 mL of solvent (e.g., from 0.06 grams to 0.1 grams, from 0.07 grams to 0.1 grams, or from 0.075 grams to 0.1 grams).

The methods can, in some examples, further comprise forming the homogenized ligand solution. For example, the methods can further comprise forming the homogenized ligand solution by contacting the ligand with the solvent under agitation to form a pre-homogenized ligand solution, and homogenizing the pre-homogenized ligand solution to form the homogenized ligand solution. Contacting the ligand with the solvent under agitation can, for example, comprise mechanical stirring. In some examples, the ligand can be contacted with the solvent under agitation for an amount of time of 5 minutes or more to form the pre-homogenized ligand solution (e.g., 10 minutes or more, 15 minutes or more, 20 minutes or more, or 25 minutes or more). In some examples, the ligand can be contacted with the solvent under agitation for an amount of time of 30 minutes or less to form the pre-homogenized ligand solution (e.g., 25 minutes or less, 20 minutes or less, 15 minutes or less, or 10 minutes or less). The amount of time that the ligand is contacted with the solvent under agitation to form the pre-homogenized ligand solution can range from any of the minimum values described above to any of the maximum values described above. For example, the ligand can be contacted with the solvent under agitation for an amount of time from 5 minutes to 30 minutes (e.g., from 5 minutes to 15 minutes, from 15 minutes to 30 minutes, from 5 to 25 minutes, from 5 minutes to 20 minutes, from 10 minutes to 20 minutes, or from 15 minutes to 20 minutes) to form the pre-homogenized ligand solution.

Homogenizing the pre-homogenized ligand solution can, for example, comprise sonicating (e.g., via bath sonication or probe sonication) the pre-homogenized ligand solution. In some examples, the pre-homogenized ligand solution can be sonicated for an amount of time of 1 minute or more to form the homogenized ligand solution (e.g., 1.5 minutes or more, 2 minutes or more, 2.5 minutes or more, 3 minutes or more, 3.5 minutes or more, or 4 minutes or more). In some examples, the pre-homogenized ligand solution can be sonicated for an amount of time of 5 minutes or less to form the homogenized ligand solution (e.g., 4.5 minutes or less, 4 minutes or less, 3.5 minutes or less, 3 minutes or less, 2.5 minutes or less, or 2 minutes or less). The amount of time that the pre-homogenized ligand solution is sonicated to form the homogenized ligand solution can range from any of the minimum values described above to any of the maximum values described above. For example, the pre-homogenized ligand solution can be sonicated for an amount of time of from 1 minute to 5 minutes to form the homogenized ligand solution (e.g., from 1 minute to 2.5 minutes, from 2.5 minutes to 5 minutes, or from 2 minutes to 4 minutes).

The homogenized aqueous metal salt solution comprises a metal salt dispersed substantially homogenously in an aqueous solvent. The aqueous solvent comprises water and, in some examples, can optionally further comprise an additional solvent selected from the group consisting of methanol, ethanol, n-butanol, isopropanol, n-propanol, lactic acid, and combinations thereof.

The metal salt can, for example, comprise a metal selected from the group consisting of Be, Mg, Al, Ca, Sc, Ti, V, Cr, Mn, Fe, Co, Ni, Cu, Zn, Ga, Sr, Y, Zr, Mo, Ag, Cd, In, Sn, Ba, W, Pt, Au, Hg, Pb, Bi, and combinations thereof. In some examples, the metal salt can comprise a metal selected from the group consisting of Ag, Cu, Zn, Co, Ni, Mn, Cd, and combinations thereof. The metal salt can, for example, comprise silver acetate, zinc acetate dihydrate, copper (II) acetate hydrate, cobalt (II) acetate tetrahydrate, manganese (II) acetate tetrahydrate, manganese (II) acetate tetrahydrate, cadmium acetate dihydrate, nickel(II) acetate tetrahydrate, or combinations thereof.

In some examples, the homogenized aqueous metal salt solution can comprise the metal salt in an amount of 0.2 grams or more per 100 mL of aqueous solvent (e.g., 0.25 grams or more, 0.3 grams or more, 0.35 grams or more, or 0.4 grams or more). In some examples, the homogenized aqueous metal salt solution can comprise the metal salt in an amount of 0.5 grams or less per 100 mL of aqueous solvent (e.g., 0.45 grams or less, 0.4 grams or less, 0.35 grams or less, or 0.3 grams or less). The amount of metal salt in the homogenized aqueous metal salt solution can range from any of the minimum values described above to any of the maximum values described above. For example, the homogenized aqueous metal salt solution can comprise the metal salt in an amount of from 0.2 to 0.5 grams per 100 mL of aqueous solvent (e.g., from 0.2 grams to 0.35 grams, from 0.35 grams to 0.5 grams, from 0.2 grams to 0.4 grams, or from 0.3 grams to 0.5 grams).

The methods can, in some examples, further comprise forming the homogenized aqueous metal salt solution. For example, the methods can further comprise forming the homogenized aqueous metal salt solution by contacting the metal salt with the aqueous solvent under agitation to form a pre-homogenized aqueous metal salt solution, and homogenizing the pre-homogenized aqueous metal salt solution to form the homogenized aqueous metal salt solution. Contacting the metal salt with the aqueous solvent under agitation can, for example, comprise mechanical stirring. In some examples, the metal salt can be contacted with the aqueous solvent under agitation for an amount of time of 5 minutes or more to form the pre-homogenized aqueous metal salt solution (e.g., 10 minutes or more, 15 minutes or more, 20 minutes or more, or 25 minutes or more). In some examples, the metal salt can be contacted with the aqueous solvent under agitation for an amount of time of 30 minutes or less to form the pre-homogenized aqueous metal salt solution (e.g., 25 minutes or less, 20 minutes or less, 15 minutes or less, or 10 minutes or less). The amount of time that the metal salt is contacted with the aqueous solvent under agitation to form the pre-homogenized aqueous metal salt solution can range from any of the minimum values described above to any of the maximum values described above. For example, the metal salt can be contacted with the aqueous solvent under agitation for an amount of time from 5 minutes to 30 minutes to form the pre-homogenized aqueous metal salt solution (e.g., from 5 minutes to 15 minutes, from 15 minutes to 30 minutes, from 5 minutes to 25 minutes, from 5 to 20 minutes, from 10 minutes to 20 minutes, or from 15 minutes to 20 minutes).

Homogenizing the pre-homogenized aqueous metal salt solution can, for example, comprise sonicating (e.g., via bath sonication or probe sonication) the pre-homogenized aqueous metal salt solution. In some examples, the pre-homogenized aqueous metal salt solution can be sonicated for an amount of time of 1 minute or more to form the homogenized aqueous metal salt solution (e.g., 1.5 minutes or more, 2 minutes or more, 2.5 minutes or more, 3 minutes or more, 3.5 minutes or more, or 4 minutes or more). In some examples, the pre-homogenized aqueous metal salt solution can be sonicated for an amount of time of 5 minutes or less to form the homogenized aqueous metal salt solution (e.g., 4.5 minutes or less, 4 minutes or less, 3.5 minutes or less, 3 minutes or less, 2.5 minutes or less, or 2 minutes or less). The amount of time the pre-homogenized aqueous metal salt solution is sonicated to form the homogenized aqueous metal salt solution can range from any of the minimum values described above to any of the maximum values described above. For example, the pre-homogenized aqueous metal salt solution can be sonicated for an amount of time from 1 minute to 5 minutes to form the homogenized aqueous metal salt solution (e.g., from 1 minute to 2.5 minutes, from 2.5 minutes to 5 minutes, or from 2 minutes to 4 minutes).

The methods further comprise agitating the mixture for an amount of time to thereby form the nanostructured metal-organic framework at room temperature. Agitating the mixture can, for example, comprise mechanical stirring. In some examples, the mixture is agitated for an amount of time of 30 minutes or less to form the nanostructured metal-organic framework (e.g., 25 minutes or less, 20 minutes or less, 15 minutes or less, 10 minutes or less, 5 minutes or less, or 1 minute or less). In some examples, the nanostructured metal-organic framework is formed in an amount of time of 30 minutes or less (e.g., 25 minutes or less, 20 minutes or less, 15 minutes or less, 10 minutes or less, 5 minutes or less, or 1 minute or less).

The nanostructured metal-organic framework can, for example, comprise Ag-BTC, Ag/NH₂-BDC, Ag-BDC, Cu-BTC, Cu-BDC, Zn-BTC, Zn-BDC, Zn/NH₂-BDC, Co-BTC, Ni-BTC, Mn-BTC, Cd-BTC, or combinations thereof.

In some examples, the nanostructured metal-organic framework can comprise a plurality of particles having an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. For an anisotropic particle, the average particle size can refer to, for example, the average maximum dimension of the particle (e.g., the length of a rod-shaped particle, the diagonal of a cube shape particle, the bisector of a triangular shaped particle, etc.) For an anisotropic particle, the average particle size can refer to, for example, the hydrodynamic size of the particle. Mean particle size can be measured using methods known in the art, such as evaluation by scanning electron microscopy, transmission electron microscopy, and/or dynamic light scattering.

In some examples, the nanostructured metal-organic framework can comprise a plurality of particles having an average particle size of 1 nanometer (nm) or more (e.g., 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 250 nm or more, 300 nm or more, 350 nm or more, 400 nm or more, 450 nm or more, 500 nm or more, 600 nm or more, 700 nm or more, or 800 nm or more). In some examples, the nanostructured metal-organic framework can comprise a plurality of particles having an average particle size of 1 micrometer (p.m, micron) or less (e.g., 900 nm or less, 800 nm or less, 700 nm or less, 600 nm or less, 500 nm or less, 450 nm or less, 400 nm or less, 350 nm or less, 300 nm or less, 250 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, or 10 nm or less). The average particle size of the plurality of particles comprising the nanostructured metal-organic framework can range from any of the minimum values described above to any of the maximum values described above. For example, the nanostructured metal-organic framework can comprise a plurality of particles having an average particle size of from 1 nm to 1 p.m (e.g., from 1 nm to 500 nm, from 500 nm to 1μm, from 1 nm to 200 nm, from 200 nm to 400 nm, from 400 nm to 600 nm, from 600 nm to 800 nm, from 800 nm to 1μm, or from 1 nm to 100 nm). In some examples, the nanostructured metal-organic framework can comprise a plurality of particles having at least one dimension with an average dimension of from 1 nm to 100 nm.

In some examples, the nanostructured metal-organic framework can comprise a plurality of particles, and the plurality of particles can be substantially monodisperse. “Monodisperse” and “homogeneous size distribution,” as used herein, and generally describe a population of particles where all of the particles have the same or nearly the same particle size. As used herein, a monodisperse distribution refers to particle distributions in which 80% of the distribution (e.g., 85% of the distribution, 90% of the distribution, or 95% of the distribution) lies within 25% of the average particle size (e.g., within 20% of the average particle size, within 15% of the average particle size, within 10% of the average particle size, or within 5% of the average particle size).

In some examples, the nanostructured metal-organic framework can comprise a plurality of particles, wherein the plurality of particles can comprise particles of any shape(s). In some examples, the nanostructured metal-organic framework can comprise a plurality of particles can have a shape that is substantially spherical, ellipsoidal, triangular, pyramidal, tetrahedral, cylindrical, rectangular, cuboidal, or cuboctrahedral.

In some examples, the nanostructured metal-organic framework comprises a plurality of particles having a shape that is substantially that of a fiber, a sheet, a rod, a sphere, a flake or a combination thereof.

The nanostructured metal-organic framework can, for example, comprise a plurality of substantially fiber-like particles having an average diameter of 10 nm or more (e.g., 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, or 90 nm or more). In some examples, the nanostructured metal-organic framework can comprise a plurality of substantially fiber-like particles having an average diameter of 100 nm or less (e.g., 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, or 20 nm or less). The average diameter of the plurality of substantially fiber-like particles comprising the nanostructured metal-organic framework can range from any of the minimum values described above to any of the maximum values described above. For example, the nanostructured metal-organic framework can comprise a plurality of substantially fiber-like particles having an average diameter of from 10 nm to 100 nm (e.g., from 10 nm to 55 nm, from 55 nm to 100 nm, from 10 nm to 40 nm, from 40 nm to 70 nm, from 70 nm to 100 nm, from 10 nm to 90 nm, from 10 nm to 70 nm, from 20 nm to 60 nm, or from 30 to 50 nm).

The nanostructured metal-organic framework can, for example, comprise a plurality of substantially rod-shaped particles having an average diameter of 1 nm or more (e.g., 2 nm or more, 3 nm or more, 4 nm or more, 5 nm or more, 10 nm or more, 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, or 90 nm or more). In some examples, the nanostructured metal-organic framework can comprise a plurality of substantially rod-shaped particles having an average diameter of 100 nm or less (e.g., 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, 10 nm or less, or 5 nm or less). The average diameter of the plurality of substantially rod-shaped particles comprising the nanostructured metal-organic framework can range from any of the minimum values described above to any of the maximum values described above. For example, the nanostructured metal-organic framework can comprise a plurality of substantially rod-shaped particles having an average diameter of from 1 nm to 100 nm (e.g., from 1 nm to 50 nm, from 50 nm to 100 nm, from 1 nm to 20 nm, from 20 nm to 40 nm, from 40 nm to 60 nm, from 60 nm to 80 nm, from 80 nm to 100 nm, from 1 nm to 80 nm, from 5 nm to 60 nm, from 10 nm to 50 nm, or from 25 to 40 nm).

The nanostructured metal-organic framework can, for example, comprise a plurality of substantially sheet-like particles having an average thickness of 1 nm or more (e.g., 2 nm or more, 3 nm or more, 4 nm or more, 5 nm or more, 10 nm or more, 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, or 90 nm or more). In some examples, the nanostructured metal-organic framework can comprise a plurality of substantially sheet-like particles having an average thickness of 100 nm or less (e.g., 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, 10 nm or less, or 5 nm or less). The average thickness of the plurality of substantially sheet-like particles comprising the nanostructured metal-organic framework can range from any of the minimum values described above to any of the maximum values described above. For example, the nanostructured metal-organic framework can comprise a plurality of substantially sheet-like particles having an average thickness of from 1 to 100 nm e.g., from 1 nm to 50 nm, from 50 nm to 100 nm, from 1 nm to 20 nm, from 20 nm to 40 nm, from 40 nm to 60 nm, from 60 nm to 80 nm, from 80 nm to 100 nm, from 10 nm to 90 nm, or from 20 nm to 80 nm).

The nanostructured metal-organic framework can, for example, comprise a plurality of substantially spherical particles having an average diameter of 200 nm or more (e.g., 225 nm or more, 250 nm or more, 275 nm or more, 300 nm or more, 325 nm or more, 350 nm or more, 375 nm or more, 400 nm or more, 425 nm or more, 450 nm or more, 475 nm or more, 500 nm or more, 525 nm or more, or 550 nm or more). In some examples, the nanostructured metal-organic framework can comprise a plurality of substantially spherical particles having an average diameter of 600 nm or less (e.g., 575 nm or less, 550 nm or less, 525 nm or less, 500 nm or less, 475 nm or less, 450 nm or less, 425 nm or less, 400 nm or less, 375 nm or less, 350 nm or less, 325 nm or less, 300 nm or less, 275 nm or less, or 250 nm or less). The average diameter of the plurality of substantially spherical particles comprising the nanostructured metal-organic framework can range from any of the minimum values described above to any of the maximum values described above. For example, the nanostructured metal-organic framework can comprise a plurality of substantially spherical particles having an average diameter of from 200 nm to 600 nm (e.g., from 200 nm to 400 nm, from 400 nm to 600 nm, from 200 nm to 300 nm, from 300 nm to 400 nm, from 400 nm to 500 nm, from 500 nm to 600 nm, or from 300 nm to 600 nm).

In some examples, the nanostructured metal-organic framework can comprise a plurality of particles and the plurality of particles can comprise: a first population of particles comprising a first material and having a first average particle size and a first particle shape; and a second population of particles comprising a second material and having a second average particle size and a second particle shape; wherein the first average particle size and the second average particle size are different, the first particle shape and the second particle shape are different, the first material and the second material are different, or a combination thereof. In some examples, nanostructured metal-organic framework can comprise a plurality of particles and the plurality of particles can comprise a mixture of a plurality of populations of particles, wherein each population of particles within the mixture has a different size, shape, composition, or combination thereof.

In some examples, the nanostructured metal-organic framework can have a BET surface area of 5 m²/g or more (e.g., 10 m²/g or more, 20 m²/g or more, 30 m²/g or more, 40 m²/g or more, 50 m²/g or more, 75 m²/g or more, 100 m²/g or more, 125 m²/g or more, 150 m²/g or more, 175 m²/g or more, 200 m²/g or more, 225 m²/g or more, 250 m²/g or more, 275 m²/g or more, 300 m²/g or more, 325 m²/g or more, 350 m²/g or more, 375 m²/g or more, 400 m²/g or more, 425 m²/g or more, or 450 m²/g or more). In some examples, the nanostructured metal-organic framework can have a BET surface area of 500 m²/g or less (e.g., 475 m²/g or less, 450 m²/g or less, 425 m²/g or less, 400 m²/g or less, 375 m²/g or less, 350 m²/g or less, 325 m²/g or less, 300 m²/g or less, 275 m²/g or less, 250 m²/g or less, 225 m²/g or less, 200 m²/g or less, 175 m²/g or less, 150 m²/g or less, 125 m²/g or less, 100 m²/g or less, 75 m²/g or less, 50 m²/g or less, 40 m²/g or less, 30 m²/g or less, or 20 m²/g or less). The BET surface area of the nanostructured metal-organic framework can range from any of the minimum values described above to any of the maximum values described above. For example, the nanostructured metal-organic framework can have a BET surface area of from 5 m²/g to 500 m²/g (e.g., from 5 m²/g to 250 m²/g, from 250 m²/g to 500 m²/g, from 5 m²/g to 100 m²/g, from 100 m²/g to 200 m²/g, from 200 m²/g to 300 m²/g, from 300 m²/g to 400 m²/g, from 400 m²/g to 500 m²/g, from 50 m²/g to 450 m²/g, or from 200 m²/g to 400 m²/g). In a specific example, the BET surface area can be 278 .7 m²/g.

In some examples, the nanostructured metal-organic framework can have an average pore volume of 0.024 cm³/g or more (e.g., 0.05 cm³/g or more, 0.1 cm³/g or more, 0.15 cm³/g or more, 0.2 cm³/g or more, 0.25 cm³/g or more, 0.3 cm³/g or more, 0.35 cm³/g or more, 0.4 cm³/g or more, 0.45 cm³/g or more, 0.5 cm³/g or more, 0.55 cm³/g or more, 0.6 cm³/g or more, 0.65 cm³/g or more, or 0.7 cm³/g or more). In some examples, the nanostructured metal-organic framework can have an average pore volume of 0.8 cm³/g or less (e.g., 0.75 cm³/g or more, 0.7 cm³/g or more, 0.65 cm³/g or more, 0.6 cm³/g or more, 0.55 cm³/g or more, 0.5 cm³/g or more, 0.45 cm³/g or more, 0.4 cm³/g or more, 0.35 cm³/g or more, 0.3 cm³/g or more, 0.25 cm³/g or more, 0.2 cm³/g or more, 0.15 cm³/g or more, or 0.1 cm³/g or more). The average pore volume of the nanostructured metal-organic framework can range from any of the minimum values described above to any of the maximum values described above. For example, the nanostructured metal-organic framework can have an average pore volume of 0.024 cm³/g to 0.8 cm³/g (e.g., from 0.024 cm³/g to 0.4 cm³/g, from 0.4 cm³/g to 0.8 cm³/g, from 0.024 cm³/g to 0.2 cm³/g, from 0.2 cm³/g to 0.4 cm³/g, from 0.4 cm³/g to 0.6 cm³/g, from 0.6 cm³/g to 0.8 cm³/g, from 0.05 cm³/g to 0.75 cm³/g, or from 0.1 cm³/g to 0.7 cm³/g). In a specific example the average pore volume can be 0.479 cm³/g.

In some examples, the nanostructured metal-organic framework can have an adsorption capacity for nitrogen gas of 5 m² or more per gram of nanostructured metal-organic framework (e.g., 10 m²/g or more, 20 m²/g or more, 30 m²/g or more, 40 m²/g or more, 50 m²/g or more, 75 m²/g or more, 100 m²/g or more, 125 m²/g or more, 150 m²/g or more, 175 m²/g or more, 200 m²/g or more, 225 m²/g or more, 250 m²/g or more, 275 m²/g or more, 300 m²/g or more, 325 m²/g or more, 350 m²/g or more, 375 m²/g or more, 400 m²/g or more, 425 m²/g or more, or 450 m²/g or more). In some examples, the nanostructured metal-organic framework can have an adsorption capacity for nitrogen gas of 500 m² or less per gram of nanostructured metal-organic framework (e.g., 475 m²/g or less, 450 m²/g or less, 425 m²/g or less, 400 m²/g or less, 375 m²/g or less, 350 m²/g or less, 325 m²/g or less, 300 m²/g or less, 275 m²/g or less, 250 m²/g or less, 225 m²/g or less, 200 m²/g or less, 175 m²/g or less, 150 m²/g or less, 125 m²/g or less, 100 m²/g or less, 75 m²/g or less, 50 m²/g or less, 40 m²/g or less, 30 m²/g or less, or 20 m²/g or less). The adsorption capacity for nitrogen gas of the nanostructured metal-organic framework can range from any of the minimum values described above to any of the maximum values described above. For example, the nanostructured metal-organic framework can have an adsorption capacity for nitrogen gas of from 5 m²/g to 500 m²/g (e.g., from 5 m²/g to 250 m²/g, from 250 m²/g to 500 m²/g, from 5 m²/g to 100 m²/g, from 100 m²/g to 200 m²/g, from 200 m²/g to 300 m²/g, from 300 m²/g to 400 m²/g, from 400 m²/g to 500 m²/g, from 50 m²/g to 450 m²/g, or from 200 m²/g to 400 m²/g). In a specific example the absorption capacity for nitrogen gas can be 278.7 m²/g of nanostructured metal-organic framework.

In some examples, the nanostructured metal-organic framework can be antimicrobial. As used herein, “antimicrobial” refers to the ability to treat or control (e.g., reduce, prevent, treat, or eliminate) the growth of a microbe at any concentration. Similarly, the terms “antibacterial,” “an tifungal,” and “antiviral” refer to the ability to treat or control the growth of bacteria, fungi, and viruses at any concentration, respectively.

As used herein, “reduce” or other forms of the word, such as “reducing” or “reduction,” refers to lowering of an event or characteristic (e.g., microbe population/infection). It is understood that the reduction is typically in relation to some standard or expected value. For example, “reducing microbial infection” means reducing the spread of a microbial infection relative to a standard or a control.

As used herein, “prevent” or other forms of the word, such as “preventing” or “prevention,” refers to stopping a particular event or characteristic, stabilizing or delaying the development or progression of a particular event or characteristic, or minimizing the chances that a particular event or characteristic will occur. “Prevent” does not require comparison to a control as it is typically more absolute than, for example, “reduce.” As used herein, something could be reduced but not prevented, but something that is reduced could also be prevented. Likewise, something could be prevented but not reduced, but something that is prevented could also be reduced.

As used herein, “treat” or other forms of the word, such as “treated” or “treatment,” refers to administration of a composition or performing a method in order to reduce, prevent, inhibit, or eliminate a particular characteristic or event (e.g., microbe growth or survival). The term “control” is used synonymously with the term “treat.”

As used herein, antimicrobials include, for example, antibacterials, antifungals, and antivirals. Examples of microbes include, but are not limited to adenoviruses, astrovirus, bacillus bacteria, blastomyces dermatitides, bovine coronavirus, bovine viral diarrhea, Brucella melitensis, clostridium bacteria, coccidioides immitits, Corynebacterium bovis , Cryptococcus neoformans, echovirus, enteroviruses, Enterobacter aerogenes, Escherichia coli, feline calicivirus (FCV), flu virus (e.g., hepatitis A, hepatitis B, herpes simplex viruses (e.g., herpes simplexl, herpes simplex 2), Klebsiella pneumoniae, Klebsiella oxytoca, Mycobacterium tuberculosis, Mycoplasma spp., norovirus, Pasteurella spp., poliovirus (e.g., polio virus type 1), pseudomonas aeruginosa, respiratory syncytial virus (RSV), rotavirus, salmonella typhosa, serratia marcescens, Staphylococcus aureus, Staphylococcus epidermidis, Streptococcus agalactiae, Streptococcus pyogenes, Streptococcus uberis, Trueperella pyogenes, vaccinia virus, Candida albicans, Aspergillus niger, Aspergillus oryzae, Fusarium oxysporum, Saccharomyces cerevisiae, and Geotrichum candidumand.

In some examples, the methods can further comprise collecting the nanostructured metal-organic framework. The nanostructured metal-organic framework can be collected in any manner chosen by the formulator, for example, the nanostructured metal-organic framework can be collected by centrifugation, filtration, or decanting. In some examples, the methods can further comprise washing and/or drying the collected nanostructured metal-organic framework.

The methods described herein can, in some examples, be performed in the substantial absence of organic solvents.

Also described herein are the nanostructured metal-organic frameworks made by any of the methods described herein.

Also described herein are articles of manufacture comprising the nanostructured metal-organic frameworks made by any of the methods described herein. Examples of articles of manufacture include, for example, filters, gas masks, human protection devices, catalysts, and the like.

The nanostructured metal-organic frameworks made by any of the methods described herein can be used, for example, in a variety of respiration and filter applications, for example for military and/or industrial uses for the removal of toxic gases and/or vapors. In some examples, the nanostructured metal-organic frameworks made by any of the methods described herein can be used in gas mask filters, respirators, collective filters, etc. The nanostructured metal-organic frameworks made by any of the methods described herein can also be used in other human protection devices, e.g., with a fabric. For example, a fabric comprising the nanostructured metal-organic frameworks made by any of the methods described herein can be formed into protective clothing, e.g., coats, pants, suits, gloves, foot coverings, head coverings, face shields, breathing scarfs. Suitable fabrics that can be combined with the nanostructured metal-organic frameworks made by any of the methods described herein include, but are not limited to, cotton, polyester, nylon, rayon, wool, silk, and the like.

The nanostructured metal-organic frameworks made by any of the methods described herein can be used to remove gases and vapors (e.g., toxic gases) from a stream of gas or liquid. The nanostructured metal-organic frameworks made by any of the methods described herein can, for example, also be used in cleaning breathing air or exhaust gases by removing various agents. The nanostructured metal-organic frameworks made by any of the methods described herein can remove toxic gases etc. by chemisorption and/or physisorption of the toxic gases by the nanostructured metal-organic frameworks made by any of the methods described herein. In some examples, the metal salt, the ligand, or a combination thereof can be chosen such that the nanostructured metal-organic frameworks made by any of the methods described herein are effective against a range of toxic agents in a gas stream.

Also disclosed herein are filters for removing a gas from a gas stream, said filter comprising any of the nanostructured metal-organic frameworks made by any of the methods described herein. Also disclosed herein are respirators comprising any of the filters disclosed herein. Also disclosed herein are gas masks comprising any of the filters described herein.

Also disclosed herein are human protection devices comprising a fabric and the nanostructured metal-organic framework formed by the any of the methods described herein.

Also disclosed herein are filters for removing a component from a fluid stream, said filter comprising any of the nanostructured metal-organic frameworks made by any of the methods described herein. For example, the filter can comprise a desalination filter, a wastewater treatment filter, a dye removal filter, a heavy metal removal filter, or a combination thereof.

The nanostructured metal-organic frameworks, filters, respirators, gas masks, and/or human protection devices described herein can, for example, be used for military, homeland security, first responder, civilian, and/or industrial applications.

Also disclosed herein are catalysts and/or catalysts supports comprising the nanostructured metal-organic framework formed by any of the method described herein.

A number of embodiments of the invention have been described. Nevertheless, it will be understood that various modifications may be made without departing from the spirit and scope of the invention. Accordingly, other embodiments are within the scope of the following claims. The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature (e.g., from 14° C. to 25° C.), and pressure is at or near atmospheric. There are numerous variations and combinations of measurement conditions, e.g., component concentrations, temperatures, pressures and other measurement ranges and conditions that can be used to optimize the described process.

### Example 1

Metal-organic frameworks are generally prepared via hydro/solvothermal approaches that comprise electrical heating in small scale at high temperature and long reaction time, e.g., from several hours to days (Lee et al. Korean Journal of Chemical Engineering 2013, 30 (9), 1667-1680). Microwave-assisted, sonochemical, electrochemical, and mechanochemical methods are alternative synthesis procedures developed with the aim of decreasing the synthesis time and producing smaller and more uniform crystals. Under normal reaction conditions (hydro/solvothermal), the organic linker and the metal ion tend to rapidly crystallize into bulk metal-organic frameworks. However, the use of both ultrasound and microwave irradiation can produce smaller size of metal-organic framework crystals due to faster reaction times compared to conventional electric heating (Safarifard et al. Coordination Chemistry Reviews 2015, 292, 1-14). Generally, each procedure for synthesizing metal organic frameworks can result in a product with different particle size, size distribution, and morphology, which indeed leads to various applications. Some of the most important of metal-organic frameworks synthesis procedures are described below.

Although originally used for the synthesis of zeolites, the hydro/solvothermal method is one of the most typical ways adapted to prepare metal-organic frameworks. In this liquid-phase synthesis technique, the reaction is performed in a closed vessel, generally Teflon-lined autoclaves, under moderate to high temperatures (e.g., in the range of 80-180° C.) and autogenous pressure for several hours or days (Seetharaj et al. Arabian Journal of Chemistry 2016). This technique involves the self-assembly of products from soluble precursors and polar solvents. The product can be influenced by the rate of cooling at the end of the reaction (Qiu et al. Coordination Chemistry Reviews 2009, 253 (23-24), 2891-2911). The parameters that can affect the nucleation and growth of the particles (crystal size and morphology) involve temperature, reaction time, pH and stoichiometry (Diring et al. Chemistry of Materials 2010, 22 (16), 4531-4538; Giménez-Marques et al. Coordination Chemistry Reviews 2016, 307, 342-360). Regardless of improvements, optimizing the particle size/shape of metal-organic frameworks through hydro/solvothermal synthesis can be particularly time-consuming and often involves high-pressure/temperature conditions. Furthermore, this method often requires toxic solvents such as DMF. Consequently, the large scale production of metal-organic frameworks by hydro/solvothermal procedure is limited due to safety and cost concerns.

Microwave-irradiation synthesis involves the interaction of electromagnetic radiation with mobile electric charges in terms of polar solvent molecules in a solution or electrons in a solid (Stock et al. Chemical reviews 2011, 112 (2), 933-969). In the case of the solution, polar molecules try to arrange themselves in an electromagnetic field and therefore the molecules change their alignments permanently. In the case of the solid, an electric current forms and the electric resistance of the solid generates heat (Hayes. Aldrichim. Acta 2004, 37 (2), 66-76). By applying a proper frequency of microwave irradiation, the molecules collide to each other and both the kinetic energy and temperature of the system increase. Microwave irradiation heating offers an energy efficient process of substantially instantaneous heating by the direct radiation of the solution/reactants, providing high heating rates and uniform heating throughout (Stock et al. Chemical reviews 2011, 112 (2), 933-969). Since the starting materials may strongly interact with the microwave radiation, the choice of appropriate solvents and selective energy input is important. Microwave irradiation synthesis of metal-organic frameworks has often been performed at a temperature higher 100° C., with reaction time rarely exceeding 1 h. Microwave irradiation synthesis of metal-organic frameworks mainly results in accelerated crystallization and the formation of a nanoscale product with a narrow particle size distribution (Stock et al. Chemical reviews 2011, 112 (2), 933-969). Compared to the conventional heating method, microwave irradiation can be a practical option due to energy input and the reaction time being reduced from hours to minutes without influencing the reaction yield or product quality (Kim et al. Crystal Growth & Design 2014, 14 (11), 5349-5355). Although, theoretically, the efficient transformation of microwave radiation into heat can facilitate scaled-up synthesis of metal-organic frameworks, practically, the penetration depth of microwave radiation into the absorbing medium is limited (Ren et al. Coordination Chemistry Reviews 2017, 352, 187-219). In this case, the benefit of fast and uniform heating resulting from microwave radiation can be lost, hindering the development of large-scale synthesis of metal-organic frameworks via microwave irradiation by limiting the size of the reactor.

The electrochemical synthesis of metal-organic frameworks involves continuous introduction of metal ions through anodic release to the reaction medium (instead of using metal salts) containing the dissolved ligand molecules and an electrolyte. Metal deposition on the cathode can be avoided by employing protic solvents, but then H₂ is generated. The electrochemical synthesis process excludes the use of harmful anions (such as nitrate, perchlorate, or chloride) during the synthesis, which provides the possibility of continuous production and therefore the possibility of attaining a higher solids content compared to normal batch reactions (Stock et al. Chemical reviews 2011, 112 (2), 933-969), which are attractive for large-scale production. The main drawback of the electrochemical synthesis method is the availability of metal ions as a metal source.

In mechanochemical synthesis, a top-down approach, a mechanical force can induce breakage of intramolecular bonds followed by a chemical transformation to form the metal organic frameworks. The grinding of starting materials from either inorganic or organic sources results in initiating a chemical reaction (Bowmaker. Chemical Communications 2013, 49 (4), 334-348). The free cations can then coordinate with the available neighboring organic ligand molecules and assemble to form the metal-organic frameworks. Mechanical synthesis of metal-organic frameworks can be performed at room temperature under solvent free conditions (little or no organic solvent), can have short reaction times (normally in the range of 10-60 min), and can provide small particles (Stock et al. Chemical reviews 2011, 112 (2), 933-969). These advantages are particularly attractive for sustainable scaled-up production. Diverse metal sources, such as pure metals, metal oxides, metal hydroxides and metal carbonates, can be used for metal-organic framework production using this method (Ren et al. Coordination Chemistry Reviews 2017, 352, 187-219). The solvent in a metal-organic framework synthesis typically affords the necessary freedom of motion for the metal ion and the organic ligand to complete the reactions. In a solvent-free metal-organic framework synthesis process, therefore, the reactions do not occur spontaneously after only simple physical mixing of the metal salt and organic ligand (Ren et al. Coordination Chemistry Reviews 2017, 352, 187-219). Consequently, additional energies such as ball milling, extrusion, and heating must be applied to trigger the reaction to form the metal organic framework. While this method exhibits certain advantages, it still suffers from disadvantages such as low production volume, high equipment shutdown time, and difficulties associated with decantation of the obtained products (Delogu et al. Progress in Materials Science 2017, 86, 75-126; Frikie et al. Nature chemistry 2013, 5 (1), 66). Moreover, in spite of the absence of solvent for the synthesis of metal-organic frameworks using this method, a solvent maybe required in a final step to purify the obtained metal-organic frameworks.

Similar to microwave irradiation, high-energy ultrasonic irradiation is another heating method that can be utilized for the simple, low-cost, environmentally friendly, and efficient production of homogeneous metal-organic frameworks with smaller particle sizes than those prepared by the hydro/solvothermal synthesis. In this sonochemical synthesis procedure, powerful ultrasound waves in the range of 20 kHz to 1 MHz are applied to a reaction mixture comprising the reactant molecules which then undergo chemical reactions (Baig et al. Chemical Society Reviews 2012, 41 (4), 1559-1584). The ultrasound waves in liquids originate from the acoustic cavitation, which is the generation, growth (tens of micrometers), and subsequent collapse of bubbles through the liquid medium (Xu et al. Chemical Society Reviews 2013, 42 (7), 2555-2567), leading to extreme local and short-time heating (Gedanken. Ultrasonics sonochemistry 2004, 11 (2), 47-55). These short life span and localized hot spots have temperatures of approximately 5000 K and pressures of near 1000 atmospheres, with heating and cooling rates above 10¹⁰ K/s (Suslick et al. Nature 1991, 353 (6343), 414), triggering chemical reactions via concentrating the diffuse sound energy into solution (Suslick et al. Sonochemistry and sonoluminescence; Springer: 1999; pp 291-320).

Even though ultrasound-assisted methods of metal-organic framework synthesis have been applied for rapid crystallization with improved product yield, the product yields obtained were less than those of conventional electric heating and microwave irradiation, which hindered the implementation of this method at an industrial scale for metal-organic framework production.

Parameters such as the type of liquid (vapor pressure, viscosity, and chemical reactivity), the temperature, or the gas atmosphere in addition to the acoustic frequency and intensity can play an important role in the production of metal-organic frameworks in the sonochemical synthesis method. Since a high vapor pressure decreases the intensity of cavitational collapse, and therefore the resulting temperatures and pressures, volatile organic solvents are often not an effective medium for sonochemistry (Shono et al. The New Chemistry 2000). Moreover, cavitation leads to the formation of microjets which erode or activate the surface of a solid surface in its vicinity. Furthermore, the size and shape of the resulting nanocrystals cannot be tuned precisely using this method (Stock et al. Chemical reviews 2011, 112 (2), 933-969).

The surfactant-assisted preparation of metal-organic frameworks allows a certain degree of control over their crystal size and morphology, and also allows their characteristics to be tuned (US 2012/0003475; WO 2017/052474). The surfactants can serve as molecular or soft templates in order to attain metal-organic frameworks with hierarchical porosity. On the other hand, surfactants can act as capping agents or inhibitors, slowing down crystal growth rate, providing steric stabilization that allows the formation of nanoparticles (Seoane et al. Coordination Chemistry Reviews 2016, 307, 147-187). However, such additives are problematic to eliminate, particularly those trapped in the cavities of the metal-organic frameworks.

Thus, despite the significant efforts in this field, there is limited synthesis scale-up for industrial applications and there is still a critical need for the development of facile, rapid, inexpensive, commercially viable, high-rate, high-quality, and/or environmentally friendly production of metal-organic frameworks. Consequently, the following issues ought to be considered for developing a large-scale production method that can meet real-life application criteria: (1) the use of inexpensive, commercially available, renewable starting materials, (2) use of small amounts of solvents or being solvent-free, (3) if solvents are used, use of green solvents such as water/ethanol instead of organic solvents, which can decrease the cost and minimize the adverse effects on the environment, (4) activation process, (5) use of energy efficient sources, (6) obtaining high yields, (7) avoiding large amounts of impurities, and (8) well-designed synthetic procedures with minimized risks in terms of use of ambient temperatures and low pressures (Stock et al. Chemical reviews 2011, 112 (2), 933-969).

Described herein is an environmentally friendly (e.g., green), room temperature synthesis of nanosized metal-organic coordination polymers (MOCPs) (e.g., metal-organic frameworks, MOFs) by a mixing of reaction solutions of organic ligands and metal cations. The method described herein is energy efficient, fast (crystallization within 20 minutes or less), uses a simple purification procedure, and has a relatively high yield. The choice of metal core and solvents can offer a versatile synthetic method for nanostructured materials that are often unavailable by traditional methods. This procedure of making nanosized metal-organic frameworks (MOFs) integrates the intrinsic characteristics of the porous materials and the benefits of nanostructures, which can improve the performances of classical bulk MOFs. Therefore, the methods discussed herein can be used for achieving continuous fabrication (rather than batch production) of nanosized metal organic frameworks on the industrial scale.

In the methods described herein, metal-organic framework nanoparticles were synthesized by direct addition of an aqueous ligand suspension (pre-homogenized by sonication) to an aqueous solution of metal salt while stirring at room temperature to complete the reaction. Generally, the methods described herein have certain advantages over the traditional methods, such as: fabrication nanosized metal-organic frameworks; room temperature synthesis procedure; short reaction time and rapid precipitation; more energy efficient than most of the current technologies; green media (applying water and ethanol instead of hazardous organic solvents); more economical (lower price of water and ethanol compared to other organic solvents); and simple purification of the nanosized metal organic frameworks (no need to solvent exchange or drying under vacuum).

Reagents: All chemicals used herein were of analytical grade and were used as received without further purification. Silver acetate, Zinc acetate dihydrate, Copper (II) acetate hydrate, Cobalt (II) acetate tetrahydrate, Manganese (II) acetate tetrahydrate, Manganese (II) acetate tetrahydrate, Cadmium acetate dihydrate, Nickel(II) acetate tetrahydrate, 1,3,5-Benzenetricarboxylic acid, 2-Aminoterephthalic acid, Terephthalic acid and ethanol were purchased from sigma Aldrich company and were used for preparation of nanosized metal-organic frameworks. Ethanol and deionized water were used as solvents where necessary, e.g. to dissolve metal salts and/or organic linkers.

Characterization: Dynamic light scattering (DLS) analysis was conducted using a Brookhaven 90Plus Particle Size Analyzer operated at 20° C. to evaluate the particle size distribution of the as synthesized metal-organic framework nanoparticles. The average of ten measurements was recorded to minimize the exponential error. The crystalline structure of the metal-organic framework nanocrystals was examined by wide-angle X-ray diffraction (XRD) employing a Bruker D8 series, GADDS X-ray diffractor (General Area Detector Diffraction System, with a Cu X-ray source, wavelength 1.54° A). The specific surface area was determined by using the Brunauer-Emmett-Teller (BET) gas adsorption method with an ASAP 2020 Plus Automatic Micropore Physisorption Analyzer. Prior to both XRD and BET analysis the metal-organic framework samples were washed with 50 ml ethanol for 30 min and then dried in a vacuum oven at 80° C. for 5 h. The morphologies of the dried MOF nanoparticles were identified by field emission scanning electron microscopy (FE-SEM, MIRA3 TESCAN).

General Synthesis Procedure of Metal-Organic Framework Nanoparticles:

The general procedure for synthesis of the nanosized metal-organic frameworks follows, with the only variations being with respect to the type of metal salt, organic linker, and the reaction time. A metal solution comprising a metal salt and a ligand solution were prepared and stirred to completely dissolve the metal salt and the ligand, respectively. After dissolution, the metal solution and the ligand solution were each that sonicated for 1 min to homogenize the solutions without any agglomeration. The homogenized ligand solution was then added to the homogenized salt solution while vigorously stirring to form a precipitate. The mixture was stirred for an appropriate time to complete the reaction. The precipitate was decanted and washed with 50 mL of ethanol two times to remove the unreacted reagents. After drying for 12 h at 120° C., the sample was taken for XRD analysis and then compared with the simulated pattern from SXRD data. Table 1 summarizes the condition of each metal-organic framework sample preparation, which are described below in more detail.

TABLE 1
Conditions for the preparation of each metal-organic framework sample.

| | | | | Reaction |
|---|---|---|---|---|
| Example | MOF type | Metal Salt | Ligand | time (min) |
| I | Ag-BTC | Silver acetate | BTC | <5 |
| | | (0.2 g/100 ml DI water) | (0.1 g/100 ml ethanol) | |
| II | Ag/NH₂-BDC | Silver acetate | BDC-NH₂ | <5 |
| | | (0.2 g/100 ml DI water) | (0.1 g/100 ml ethanol) | |
| III | Ag-BDC | Silver acetate | BDC | <5 |
| | | (0.2 g/100 ml DI water) | (0.05 g/100 ml ethanol) | |
| IV | Cu-BTC | Copper (II) acetate hydrate | BTC | <10 |
| | | (0.5 g/100 ml DI water) | (0.1 g/100 ml ethanol) | |
| V | Cu-BDC | Copper (II) acetate hydrate | BDC | <10 |
| | | (0.5 g/100 ml DI water) | (0.05 g/100 ml ethanol) | |
| VI | Zn-BTC | Zinc acetate dihydrate | BTC | <5 |
| | | (0.5 g/100 ml DI water) | (0.1 g/100 ml ethanol) | |
| VII | Co-BTC | Cobalt (II) acetate | BTC | <15 |
| | | tetrahydrate | (0.1 g/100 ml ethanol) | |
| | | (0.3 g/100 ml DI water) | | |
| VIII | Ni-BTC | Nickel (II) acetate | BTC | <20 |
| | | tetrahydrate | (0.1 g/100 ml ethanol) | |
| | | (0.5 g/100 ml DI water) | | |
| IX | Mn-BTC | Manganese (II) acetate | BTC | <10 |
| | | tetrahydrate | (0.1 g/100 ml ethanol) | |
| | | (0.3 g/100 ml DI water) | | |
| X | Cd-BTC | Cadmium acetate | BTC | <5 |
| | | dihydrate | (0.1 g/100 ml ethanol) | |
| | | (0.2 g/100 ml DI water) | | |

BTC = Benzene-1,3,5-tricarboxylic acid
BDC-NH₂ = 2-aminoterephthalic acid
BDC = terephthalic acid

### Example I

### Synthesis of Ag-BTC

Siver acetate (0.2 g) was dissolved in 100 mL of deionized water. Benzene-1,3,5-tricarboxylic acid (BTC, 0.1 g) was dissolved in 100 mL of ethanol. The mixture of the ligand solution and metal salt solution was stirred for 5 min to complete the reaction.

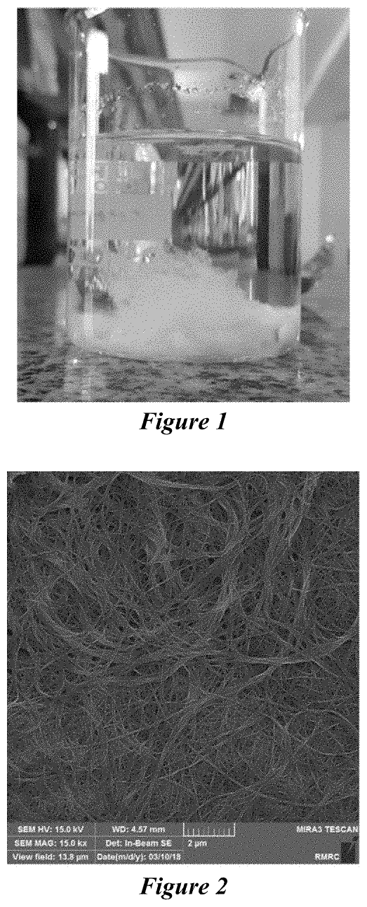

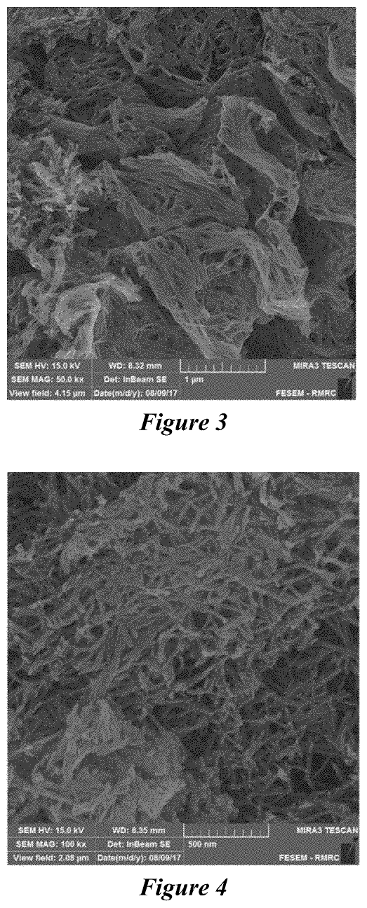

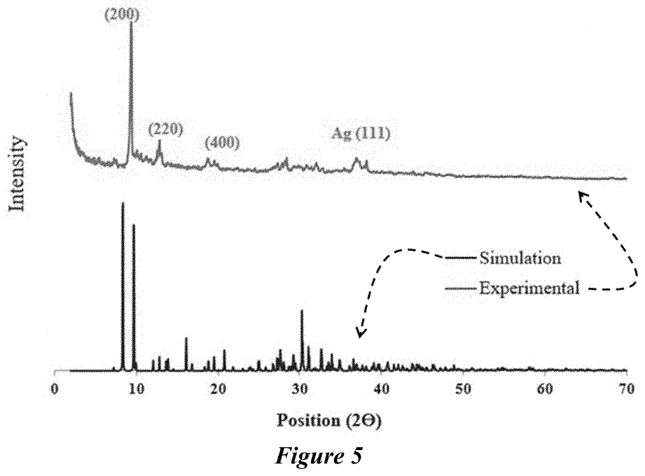

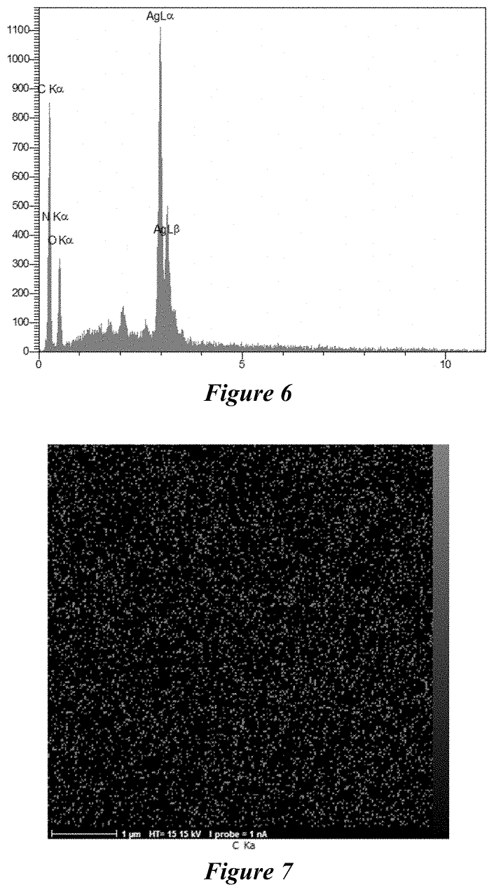

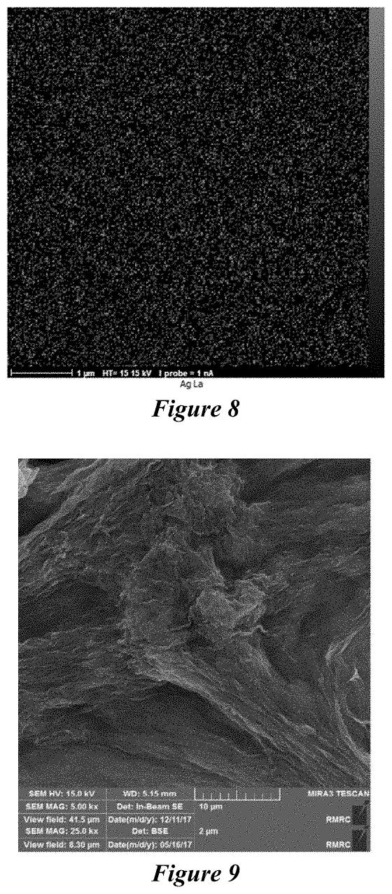

FIG. 1 is a digital photograph of the as synthesized Ag-BTC nanofibers. FIG. 2-FIG. 4 are FE-SEM images of the Ag-BTC nanofibers. As can be seen from FIGS. 1-FIG. 4, the nanofibers of Ag-BTC are substantially uniform and have a narrow size distribution; the fiber sizes generally fall within the range of 30 to 50 nm. The XRD analysis of the Ag-BTC metal-organic frameworks is shown in FIG. 5; the main peak of the sample is in accordance with the main peak of the simulation (with a negligible 1 degree deviation). Additionally, both the EDX and EDX-mapping of Ag-BTC indicate the existence of silver and carbon atoms on the structure of Ag-MOFs nanofibers (FIG. 6-FIG. 8).

### Example II

### Synthesis of Ag—NH₂-BDC

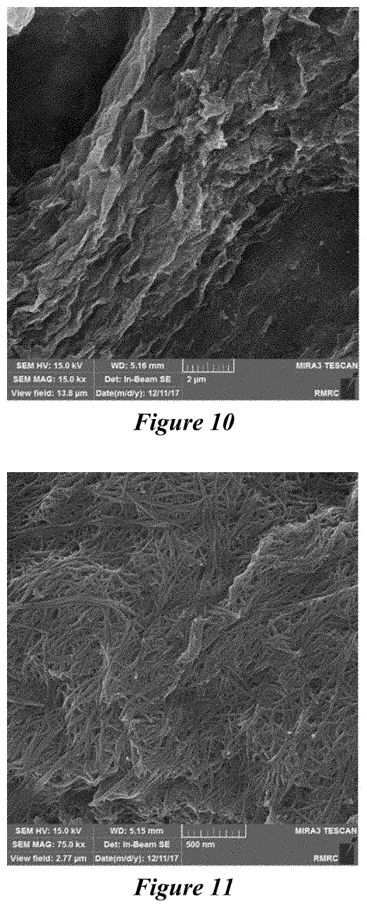

Silver acetate (0.2 g) was dissolved in 100 mL of deionized water. 2-Aminoterephthalic acid (NH₂-BDC, 0.1 g) was dissolved in 100 mL of ethanol. The mixture of the ligand and metal salt solutions was stirred for 5 min to complete the reaction. FIG. 9-FIG. 11 show the FE-SEM images of the resulting Ag—NH₂ nanofibers, which are substantially uniform and have a narrow size distribution; the fiber sizes generally fall within the range 30 to 50 nm.

### Example III

### Synthesis of Ag-BDC

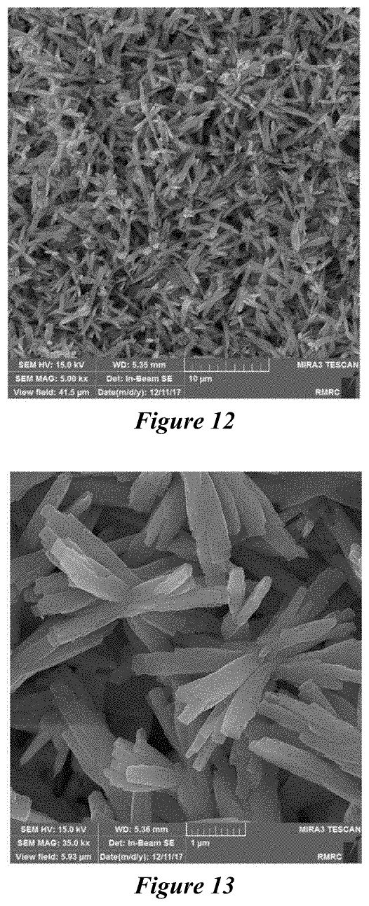

Silver acetate (0.2 g) was dissolved in 100 mL of deionized water. Terephthalic acid (BDC, 0.05 g) was dissolved in 100 mL of ethanol. The mixture of the ligand and metal salt solutions was stirred for 5 min to complete the reaction. FIG. 12-FIG. 14 show the FE-SEM images of the resulting Ag-BDC nanosheets that are substantially uniform and have a narrow size distribution.

### Example IV

### Synthesis of Cu-BTC

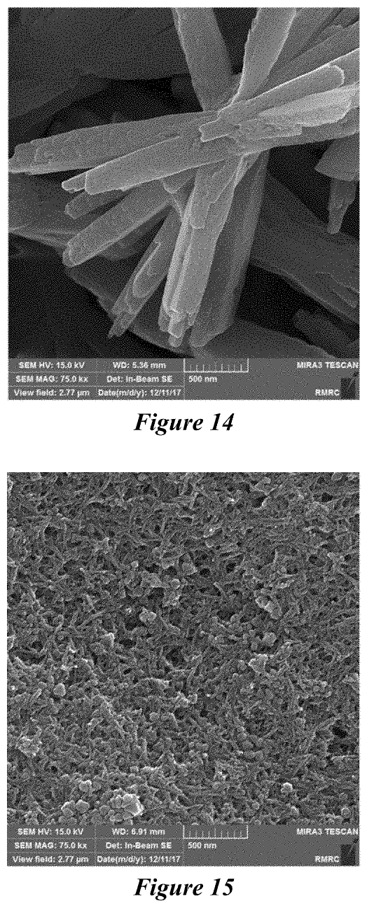

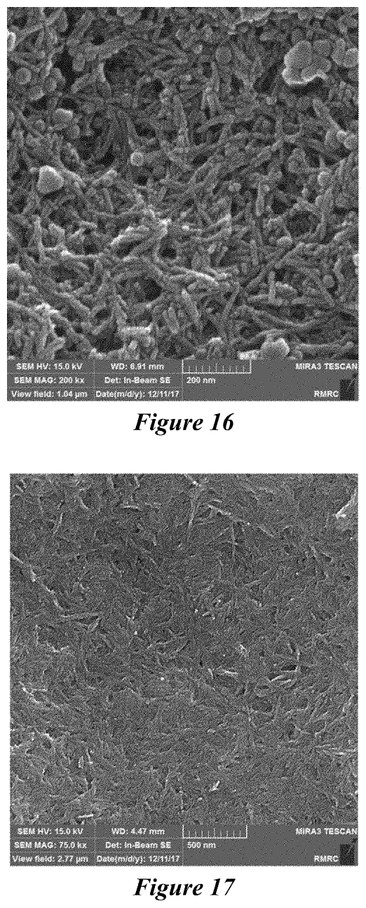

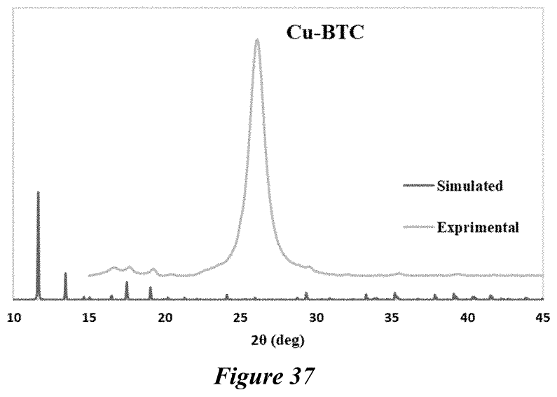

Copper (II) acetate hydrate (0.5 g) was dissolved in 100 mL of deionized water. Benzene-1,3,5-tricarboxylic acid (BTC, 0.1 g) was dissolved in 100 mL of ethanol. The mixture of the ligand and metal salt solutions was stirred for 10 min to complete the reaction. FIG. 15-FIG. 16 show the FE-SEM images of the resulting Cu-BTC metal organic frameworks, which formed a mixture of nanorods and nanoparticles. The nanorods are substantially uniform and have a narrow size distribution, generally falling within the range 25 to 40 nm. FIG. 37 shows the XRD pattern of Cu-BDC.

### Example V

### Synthesis of Cu-BDC

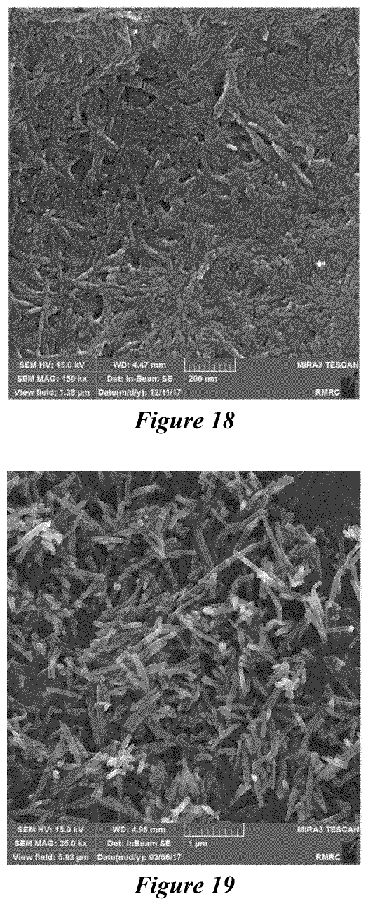

Copper (II) acetate hydrate (0.5 g) was dissolved in 100 mL of deionized water. Terephthalic acid (BDC, 0.05 g) was dissolved in 100 mL of ethanol. The mixture of the ligand and metal salt solutions was stirred for 10 min to complete the reaction. FIG. 17-FIG. 18 show the FE-SEM images of the resulting Cu-BDC nanorods, which are substantially uniform and have a narrow size distribution; the rod sizes generally fall within the range 25 to 40 nm.

### Example VI

### Synthesis of Zn-BTC

Zinc acetate dihydrate (0.5 g) was dissolved in 100 mL of deionized water. Benzene-1,3,5-tricarboxylic acid (BTC, 0.1 g) was dissolved in 100 mL of ethanol. The mixture of the ligand and metal salt solutions was stirred for 5 min to complete the reaction.

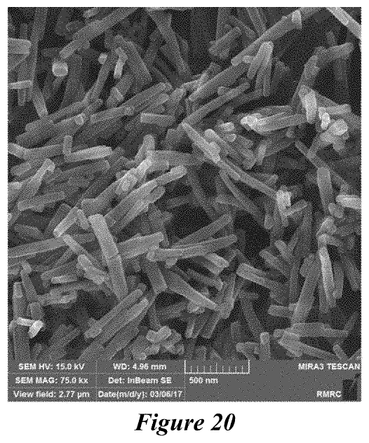

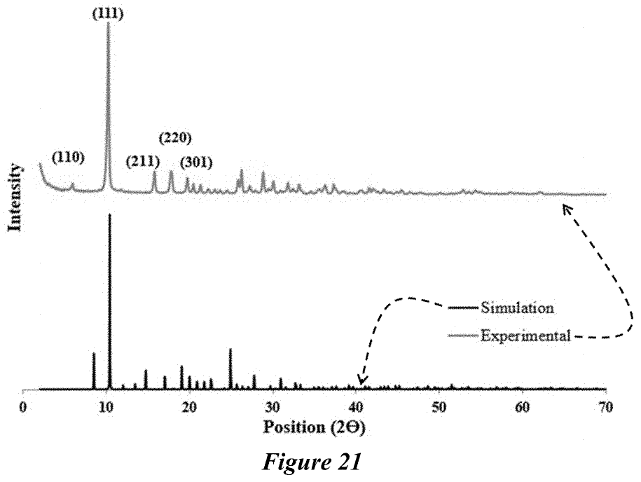

FIG. 19-FIG. 20 show the FE-SEM images of the resulting Zn-BTC nanorods, which are substantially uniform and have a narrow size distribution; the nanorod sizes generally fall within the range 50 to 80 nm. FIG. 21 shows the powder X-ray diffraction (PXRD) pattern of the as-synthesized Zn-BTC nanorods in comparison with the simulated pattern from SXRD data. The results in FIG. 21 show that the main peak of the as-synthesized sample is in accordance with the main peak of simulation.

### Example VII

### Synthesis of Co-BTC

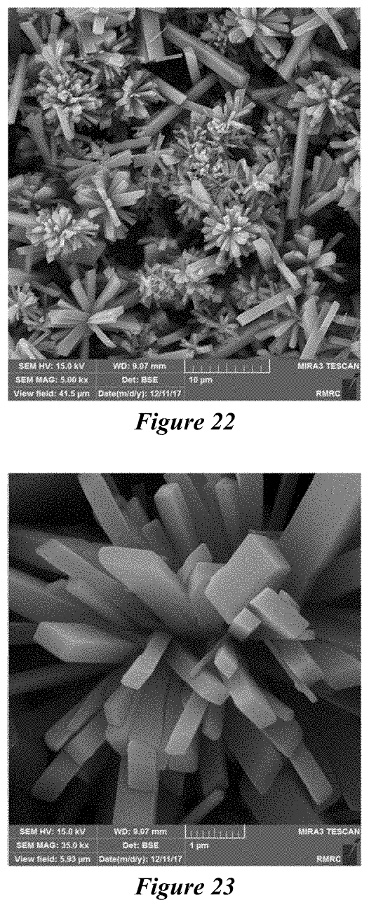

Cobalt (II) acetate tetrahydrate (0.3 g) was dissolved in 100 mL of deionized water. Benzene-1,3,5-tricarboxylic acid (BTC, 0.1 g) was dissolved in 100 mL of ethanol. The mixture of the ligand and metal salt solutions was stirred for 15 min to complete the reaction. FIG. 22-FIG. 23 show the FE-SEM images of the resulting Co-BTC cubic orthorhombic nanorods, which are substantially uniform and have a narrow size distribution. FIG. 34 shows the XRD pattern of Co-BTC.

### Example VIII

### Synthesis of Ni-BTC

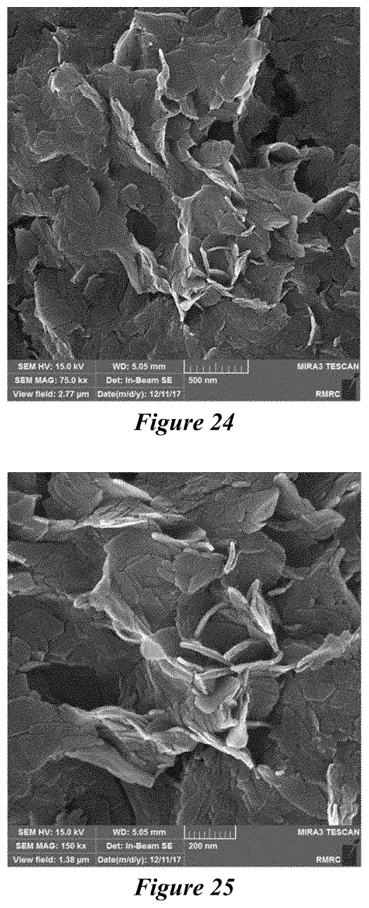

Nickel (II) acetate tetrahydrate (0.5 g) was dissolved in 100 mL of deionized water. Benzene-1,3,5-tricarboxylic acid (BTC, 0.1 g) was dissolved in 100 mL of ethanol. The mixture of the ligand and metal salt solutions was stirred for 20 min to complete the reaction. FIG. 24-FIG. 25 show the FE-SEM images of the resulting Ni-BTC lamellar nanosheets, which are substantially uniform and have a narrow size distribution. FIG. 36 shows the XRD pattern of Ni-BTC.

### Example IX

### Synthesis of Mn-BTC

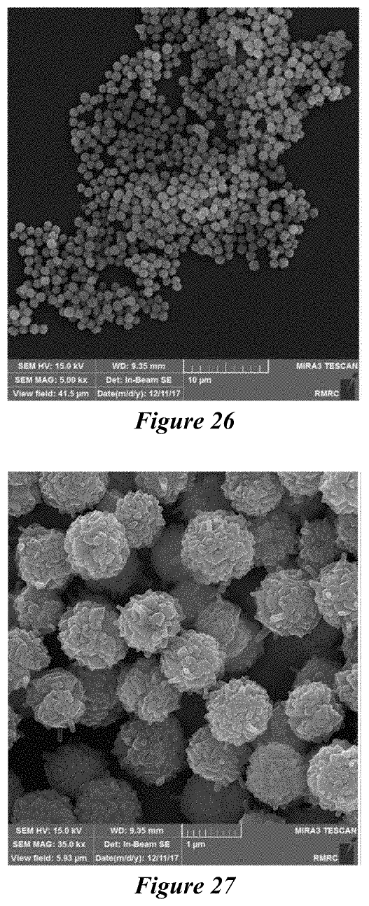

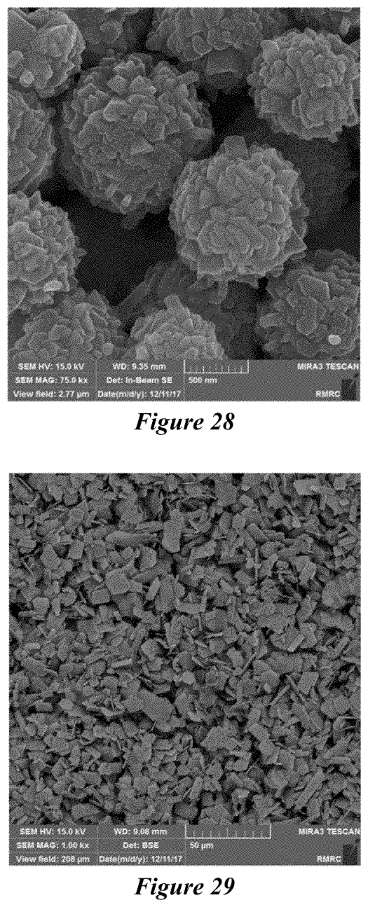

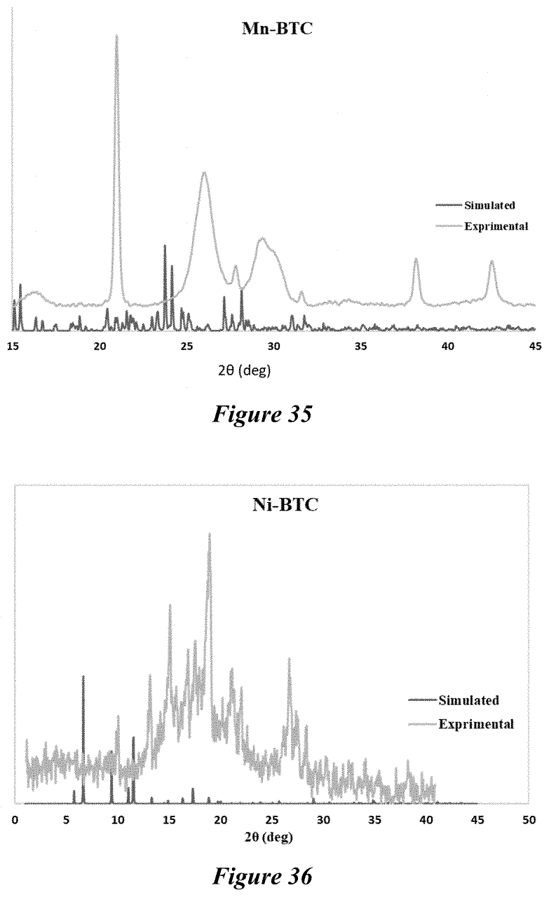

Manganese (II) acetate tetrahydrate (0.3 g) was dissolved in 100 mL of deionized water. Benzene-1,3,5-tricarboxylic acid (BTC, 0.1 g) was dissolved in 100 mL of ethanol. The mixture of the ligand and metal salt solutions was stirred for 10 min to complete the reaction. FIG. 26-FIG. 28 show the FE-SEM images of the resulting Mn-BTC nanospheres, which are substantially uniform and have a narrow size distribution. FIG. 35 shows the XRD pattern of Mn-BTC.

### Example X

### Synthesis of Cd-BTC

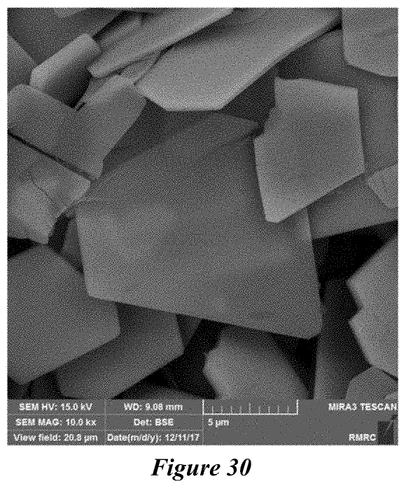

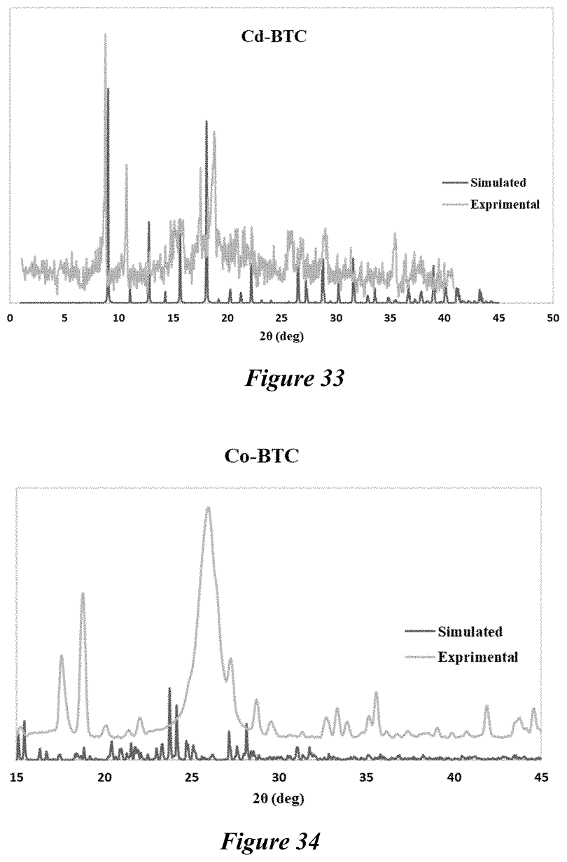

Cadmium acetate dihydrate (0.2 g) was dissolved in 100 mL of deionized water. Benzene-1,3,5-tricarboxylic acid (BTC, 0.1 g) was dissolved in 100 mL of ethanol. The mixture of the ligand and metal salt solutions was stirred for 5 min to complete the reaction. FIG. 29-FIG. 30 show the FE-SEM images of the Cd-BTC nanosheets, which are substantially uniform and have a narrow size distribution. The thickness of nanosheets is substantially the same. FIG. 33 shows the XRD pattern of Cd-BTC.

### Example XI

### Synthesis of Zn-BDC and Zn—NH₂-BDC

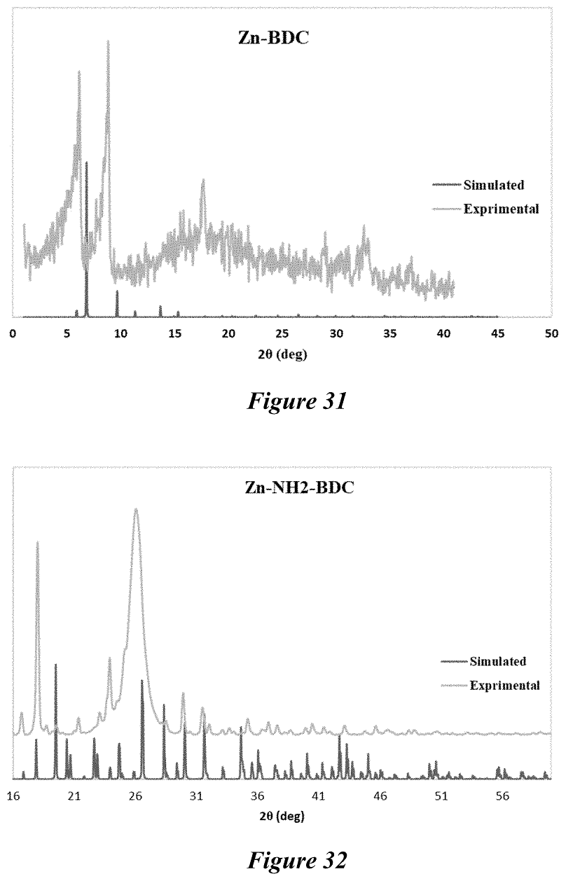

Zn-BDC and Zn—NH₂-BDC were synthesized using the methods described herein. FIG. 31 and FIG. 32 show the XRD pattern of Zn-BDC and Zn—NH₂-BDC, respectively.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A method of making a nanostructured metal-organic framework, the method comprising:
contacting a homogenized ligand solution with a homogenized aqueous metal salt solution at room temperature to form a mixture; and
agitating the mixture for an amount of time to thereby form the nanostructured metal-organic framework at room temperature;
wherein the homogenized ligand solution comprises a ligand dispersed substantially homogenously in a solvent selected from the group consisting of water, ethanol, isopropanol, n-propanol, lactic acid, and combinations thereof; and
wherein the homogenized aqueous metal salt solution comprises a metal salt dispersed substantially homogenously in an aqueous solvent.

2. The method of claim 1, wherein the homogenized ligand solution comprises the ligand in an amount of from 0.05 to 0.1 gram per 100 mL of solvent.

3. The method of claim 1, wherein the ligand comprises 1,3,5-Benzenetricarboxylic acid (BTC), 2-Aminoterephthalic acid (BDC-NH₂), Terephthalic acid (BDC), or a combination thereof.

4. The method of claim 1, wherein the method further comprises:
forming the homogenized ligand solution by contacting the ligand with the solvent under agitation to form a pre-homogenized ligand solution and homogenizing the pre-homogenized ligand solution to form the homogenized ligand solution; and/or
forming the homogenized aqueous metal salt solution by contacting the metal salt with the aqueous solvent under agitation to form a pre-homogenized aqueous metal salt solution and homogenizing the pre-homogenized aqueous metal salt solution to form the homogenized aqueous metal salt solution.

5. The method of claim 4, wherein the ligand is contacted with the solvent under agitation and/or wherein the metal salt is contacted with the aqueous solvent under agitation, and wherein the agitation comprises mechanical stirring.

6. The method of claim 4, wherein the ligand is contacted with the solvent under agitation for an amount of time from 5 minutes to 30 minutes to form the pre-homogenized ligand solution; wherein the metal salt is contacted with the aqueous solvent under agitation for an amount of time from 5 minutes to 30 minutes to form the pre-homogenized aqueous metal salt solution; or a combination thereof.

7. The method of claim 4, wherein homogenizing the pre-homogenized ligand solution comprises sonicating the pre-homogenized ligand solution; wherein homogenizing the pre-homogenized aqueous metal salt solution comprises sonicating the pre-homogenized aqueous metal salt solution; or a combination thereof.

8. The method of claim 7, wherein the pre-homogenized ligand solution is sonicated for an amount of time from 1 minute to 10 minutes to form the homogenized ligand solution;
wherein the pre-homogenized aqueous metal salt solution is sonicated for an amount of time from 1 minute to 5 minutes to form the homogenized aqueous metal salt solution; or a combination thereof.

9. The method of claim 1, wherein the homogenized aqueous metal salt solution comprises the metal salt in an amount of from 0.2 to 0.5 per 100 mL of aqueous solvent.

10. The method of claim 1, wherein the metal salt comprises a metal selected from the group consisting of Ag, Cu, Zn, Co, Ni, Mn, Cd, and combinations thereof.

11. The method of claim 1, wherein the metal salt comprises silver acetate, zinc acetate dihydrate, copper (II) acetate hydrate, cobalt (II) acetate tetrahydrate, manganese (II) acetate tetrahydrate, manganese (II) acetate tetrahydrate, cadmium acetate dihydrate, nickel(II) acetate tetrahydrate, or combinations thereof.

12. The method of claim 1, wherein the aqueous solvent comprises water and an additional solvent selected from the group consisting of methanol, ethanol, isopropanol, n-propanol, lactic acid, and combinations thereof.

13. The method of claim 1, wherein the nanostructured metal-organic framework is formed in an amount of time of 30 minutes or less.

14. The method of claim 1, wherein the nanostructured metal-organic framework comprises Ag-BTC, Ag/NH₂-BDC, Ag-BDC, Cu-BTC, Cu-BDC, Zn-BTC, Co-BTC, Ni-BTC, Mn-BTC, Cd-BTC, or combinations thereof.

15. The method of claim 1, wherein the nanostructured metal-organic framework has a BET surface area of from 5 to 500 m²/g; wherein the nanostructured metal-organic framework has; an average pore volume of from 0.024 to 0.8 cm³/g; wherein the nanostructured metal-organic framework has; an adsorption capacity for nitrogen gas of from 5 to 500 m2/g _{— of} nanostructured metal-organic framework; wherein the nanostructured metal-organic framework is antimicrobial; or a combination thereof.

16. The method of claim 1, wherein the method is performed in the substantial absence of organic solvents.

17. A nanostructured metal-organic framework made by the method of claim 1.

18. An article of manufacture comprising the nanostructured metal-organic framework formed by the method of claim 1, wherein the article of manufacture comprises a filter for removing a gas from a gas stream, a filter for removing a component from a fluid stream, a respirator, a gas mask, a human protection device, or a combination thereof.

19. The article of manufacture of claim 18, wherein the article of manufacture comprises a filter for removing a component from a fluid stream and the filter comprises a desalination filter, a wastewater treatment filter, a dye removal filter, a heavy metal removal filter, or a combination thereof.

20. A catalyst or catalyst support comprising the nanostructured metal-organic framework formed by the method of claim 1.
